(19) United States
(12) Patent Application Publication
(10) Pub. No.: US 2001/0027481 A1
(43) Pub. Date: Oct. 4, 2001

(54) Method and system for appointment/reservation scheduling

(76) Inventor: Gabriel C. Whyel, Philadelphia, PA (US)

Correspondence Address: Dilworth & Barrese, LLP, 333 Earle Ovington Blvd., Uniondale, NY, 11553, US

(21) Appl. No.: 09/779,305

(22) Filed: Feb. 8, 2001

Related U.S. Application Data
(60) Provisional application No. 60/181,399, filed on Feb. 9, 2000.

(51) Int. Cl. G06F 15/16

(52) U.S. Cl. 709/218; 709/204

(57) ABSTRACT

The present invention is a scheduling method and apparatus for scheduling appointments/reservations between Service Providers offering services and End Users seeking to schedule services. In a preferred embodiment, the apparatus of the present invention includes a Central Controller for mediating the scheduling method including a database for storing Service Provider schedules. In one embodiment, the controller receives an End User request including an appointment/reservation type and day of desired service. A scheduling program displays a Service Provider schedule, including available times and appointment/reservation types, to respond to the End User request. The End User then secures an available appointment/reservation from the displayed schedule. The scheduling program analyzes the request and returns a confirmation/rejection in response. The method and apparatus of the present invention have applications via computer networks, such as the Internet, as well as conventional voice telephony systems.

### PRIORITY

This application claims priority from a U.S. Provisional Application filed on Feb. 9, 2000 having U.S. Application Provisional Ser. No. 60/181,399; the contents of which are incorporated herein by reference.

### BACKGROUND OF THE INVENTION

1. Field of the Invention

The present invention relates generally to a method and system for scheduling appointments/reservations and other schedule interactions between participants. More particularly, the present invention relates to a method and system for facilitating the scheduling of services between a plurality of participating Service Providers and End Users over a network.

2. Description of the Related Art

Methods and systems for scheduling events over an electronic network are well known. Such methods and systems are generally designed to provide greater convenience to Web-savvy consumers, allowing them to leverage their know-how to get better deals, more choices, and greater convenience by booking arrangements via the Web.

Prior to the advent of electronic networks, like the Internet, reservation based companies mainly attracted customers by advertising in publications such as Yellow Pages, Golf Digest and Zagat's. This approach is effective since it focuses on specific demographic groups and provides key products and service related information to prospective customers. After choosing a desired company from an advertisement, a customer would check reservation availability via the phone or by fax, and if a desired time slot is available, a reservation is made. This approach requires service personnel to answer phones and to schedule and maintain the appointments.

More recently, given the explosive growth of the Internet, the reservation process has evolved to conform to the new electronic medium. More specifically, a company would disseminate information about themselves either through industry-specific listings, or through the company's web site. The consumer may then choose the desired company from a web listing to make a reservation. This more recent approach in making electronic reservations/appointments is evidenced by such websites as Zagat's.com which accommodate the making of dinner reservations over the Internet, and Cybergolf.com which specialize in reserving golf tee times over the Internet.

Making reservations over the Internet has been gaining ever-increasing acceptance by consumers, as evidenced by statistics associated with the online travel industry. Approximately one-third of Internet users who visit travel-related sites have made on line reservations via those sites. Making travel arrangements is a natural application for the Internet. Revenue in 1998 exceeded $1.8 billion, according to several Internet market-research organizations. A leading survey by E-Travel reveals that companies that adopt online-booking software can reduce travel costs by as much as 20 percent. It is estimated that the 30,000-plus physical agencies that currently handle between 80-85 percent of ticket sales to decrease by several percentage points as airlines begin selling tickets via the Web to cut down on costs. The dollar value of such online reservations is estimated to rise by $4.5 billion by 2001 as online reservations reach $8 billion.

While the process of making reservations over the Internet provides advantages over more traditional approaches, it suffers from some of the same drawbacks as the traditional reservation methods discussed above. That is, a reservation must still be made or confirmed by some traditional communication method such as a telephone, fax, or e-mail. While the use of e-mail has proven to be more convenient to making phone calls to confirm a reservation, it is less than an optimum solution in that it requires that an e-mail be sent from a consumer to the company, with a confirmation/rejection sent back in response. This approach does not overcome the shortcomings of previous approaches in that it does not alleviate the requirement of providing personnel to manually handle the e-mail requests. In addition, consumers must wait to receive a confirmation/rejection. A further drawback is that e-mail complicates the reservation process since it is an additional source of maintenance.

A need therefore exists for a more integrated and fully-automated system that allows users to schedule appointments/reservations and other schedule interactions over a electronic network, such as the Internet, with multiple-diverse Service Providers encompassing a wide breadth of industry categories all with their own unique scheduling processes and without human intervention.

### SUMMARY OF THE INVENTION

In accordance with the present invention, there is provided a system and method which improves an End user's ability to schedule appointments/reservations and other schedule interactions with multiple, diverse Service Providers over an electronic network, such as the Internet, in real-time without human intervention. Accordingly, the present system and method improves the ability for Service Providers to provide their services to many End users.

In one embodiment, at a registration stage, service providers use the Service Provider Interfaces provided by the invention to input their proprietary service offerings and identify how those service offerings are reserved by end users. The service configurations are stored at a Central Controller. The service provider service offerings may be, for example, a service bay for automotive oil changes, real estate agents for appraisals, rental equipment, etc. At an operational stage, end users can access the Central Controller to view a real-time display of a listing of available appointment/reservation times for a particular service provided by one of the registered Service Providers thereby facilitating the End User's ability to secure an appointment/reservation for the desired service, in real-time without human intervention.

The invention thus offers an end user the convenience of scheduling appointments/reservations with multiple, diverse Service Providers at a central location, in real-time without human intervention(e.g., without the need for e-mails, phones, or faxes). The system includes: a Central Controller including data storage for storing one or more appointment/reservation schedules provided by participating Service Providers; at least one schedule requesting computer for operation by an End User desiring to secure an appointment/reservation, and at least one schedule providing computer, operated by a registered Service Provider, for providing one or more service schedules listing available appointment/reservation times, where each service schedule corresponds to a particular service category of the Service Provider. The Central Controller, service requesting computer, and schedule providing computer are all interconnected by an electronic network, e.g., the Internet.

In accordance with another aspect of the invention, there is provided a method for facilitating the scheduling of an appointment/reservation over an electronic network. The method includes the steps of: storing in a data storage system service schedules provided by a plurality of registered Service Providers including data identifying each Service Provider; receiving a schedule request from an End User to view in real-time a Service Provider's service schedule for a particular service type, wherein the displayed schedule includes a listing of available appointment/reservation times; displaying the service schedule to the End User in response to the End User schedule request; processing in a data processing system the schedule request to determine if the schedule request can be satisfied; and transmitting a confirmation or rejection from a Central Controller in response to the schedule request.

In accordance with one aspect of the present invention, an end user's confirmed request is bound by the Service Provider. In this case, the Service Provider can choose to bind the End User on an “honor system” or instead require a credit card to secure a schedule request (i.e., appointment/reservation).

The present invention enjoys the further advantage of not requiring proprietary software. Simply reaching the controller's website on the Internet, for example, allows for any end user to use the service. Standardized encryption techniques, including public key protocols can be used to ensure privacy and message integrity.

It is the goal of the present invention to provide a robust system which facilitates the scheduling of appointments/reservations to improve a Service Provider's ability to efficiently provide services and the End User's ability to schedule services with Service Providers capable and willing to furnish such services.

### BRIEF DESCRIPTION OF THE DRAWINGS

The foregoing features of the present invention will become more readily apparent and may be understood by referring to the following detailed description of an illustrative embodiment of the present invention, taken in conjunction with the accompanying drawings, where:

FIG. 1 is a block diagram showing information flow between relevant parties according to one embodiment of the present invention;

FIG. 2 is a detailed block diagram of a Service Provider and End User interface according to one embodiment of the present invention;

FIG. 3 is a block diagram showing one embodiment of the Central Controller;

FIG. 4 is an illustration of a database table referred to as the END USER database shown in FIG. 3;

FIG. 5 is an illustration of a database table referred to as the SERVICE PROVIDER database shown in FIG. 3;

FIG. 6 is an illustration of a database table referred to as the RESOURCE database shown in FIG. 3;

FIG. 7 is an illustration of a database table referred to as the SERVICE database shown in FIG. 3;

FIG. 8 is an illustration of a database table referred to as the APPOINTMENT database shown in FIG. 3;

FIG. 9 is an illustration of a database table referred to as the RESOURCE CACHE database shown in FIG. 3;

FIG. 10 is an illustration of a database table referred to as the SERVICE/RESOURCE MAPPING database shown in FIG. 3;

FIG. 11 is an illustration of a database table referred to as the APPOINTMENT/RESOURCE MAPPING database shown in FIG. 3;

FIGS. 12A-B are flowcharts illustrating the process by which a Service Provider configures and uploads one or more service schedules to the Central Controller, according to a preferred embodiment of the present invention;

FIGS. 13A-C are flowcharts illustrating the process by which an End User attempts to schedule an appointment/reservation with a registered Service Provider via the Central Controller, according to a preferred embodiment of the present invention; and

FIGS. 14A-C are flowcharts illustrating an exemplary execution of the process illustrated by FIG. 13.

### DETAILED DESCRIPTION OF THE PREFERRED EMBODIMENTS

In this section, the present invention is described in detail with regard to the figures briefly described above. The following terms are used throughout the remainder of this section. For purposes of construction, such terms shall have the following meanings:

End User: is any entity having a need to schedule an appointment/reservation with a Service Provider. An End User/schedule requester may be, for example, an individual, a business representative, a Service Provider, a government representative.

Service Provider: is any service entity registered with the Central Controller making his/her services available by providing one or more service schedules to the Central Controller to be viewed and accessed by End Users.

Resource: any corporate asset that provides a service to an End User and is renewed after consumption. Examples include facilities (i.e. conference rooms, etc.), equipment (i.e. automobile tire alignment equipment, etc.), and employees (i.e. Human Resources Recruiter, etc.)

Server: Any computer that performs a task at the command of another computer is a server. A web server typically supports one or more End Users.

Internet Browser or Web browser: A graphical interface tool that runs Internet protocols such as HTTP, and display results on the customers screen. The browser can act as an Internet tour guide, complete with pictorial desktops, directories and search tools used when a user “surfs” the Internet. In this application the Web browser is a client service which communicates with the World Wide Web.

Internet: A collection of interconnected (public and/or private) networks that are linked together by a set of standard protocols (such as, TCP/IP and HTTP) to form a global, distributed network. (While this term is intended to refer to what is now commonly known as the Internet, it is also intended to encompass variations including changes and additions to existing standard protocols.)

World Wide Web (“Web”): Used herein to refer generally to both (I) a distributed collection of interlinked, user-viewable hypertext documents (commonly referred to as web documents or web pages) that are accessible via the Internet, and (ii) the client and server software components which provide user access to such documents using standardized Internet protocols. Currently, the primary standard protocol for allowing applications to locate and acquire web documents is HTTP, and the Web pages are encoded using HTML.

However, the terms “web” and “World Wide Web” are intended to encompass future markup languages and transport protocols which may be used in place of (or in addition to) HTML and HTTP.

Web Site: A computer system that serves informational content over a network using the standard protocols of the World Wide Web. Typically, a web site corresponds to a particular Internet domain name, or URL, such as “yahoo.com,” and includes the content associated with a particular organization. As used herein, the term is generally intended to encompass both (I) the hardware/software server components that serve the informational content over the network, and (ii) the “back end” hardware/software components, including any non-standard or specialized components, that interact with the server components to perform services for Web site users.

Registration stage: a stage at which Service Providers register with a Central Controller by inputting service and resource configuration data to be stored in a Resource and Service databases at the Central Controller. In addition to the provided service and resource data, a Service Provider also inputs Service Provider identification data including a unique Service Provider identifier, login, password, company name, type of business, location, contact information, activation setting, to be stored in a Schedule Provider database.

The aforementioned and defined terms are used below to describe the preferred embodiments of the present invention. Where appropriate, like parts are referred to with like reference numerals.

The following paragraphs illustrate the structural and operational aspects of the present invention. The structural aspects are illustrated first and are followed by discussions of the operational aspects.

I. System Architecture

The system architecture of a preferred embodiment of the apparatus and method of the present invention is illustrated by FIGS. 1 through 3. FIG. 1 illustrates the general architecture of a scheduling system that operates in accordance with the present invention, generally indicated as numeral 10. In the preferred embodiment, the system includes Central Controller 300 and associated databases (described in detail in FIGS. 2 and 3), a plurality of end user computers 305, having an associated End User interface 310, operated by End Users 320 desiring to schedule a service (e.g. appointment, reservation), a plurality of service provider computers 340, having an associated Service Provider interface 330, operated by Service Providers 350 willing to provide a service to the plurality of End Users 320. Service Provider interfaces 330 and End User interfaces 310 collectively define the “nodes”, and are the input and output gateways for communications with Central Controller 300. Although only three end user computers 305 and three service providing computers 340 are shown in FIG. 1, it will be understood by those skilled in the art that the invention is applicable to one or more schedule requesting computers and service providing computers.

End User computer 305 and schedule provider computer 340 may be, for example, a personal computer, a workstation, a terminal device, or equivalent computer processing hardware. The End User 320 may be, for example, an individual, a business representative, a Service Provider, a government representative, or any entity with the need to make an appointment/reservation with one of the Service Providers 350 registered with the system.

The Service Provider 350 may be a business, for example, a financial services company, real estate office, law office, dentist, automotive service department, equipment rental facility, bed and breakfast, or any entity providing a service that requires the making of an appointment/reservation for the service to be provides. The Central Controller 300 is preferably controlled and managed by a third party, independent of the End Users 320 and Service Providers 350. Central Controller 300 is discussed in detail below with reference to FIG. 3.

The Service Providing Computer 340, Service Requesting Computer 305, and Central Controller 300 are all linked to each other over an electronic network. It is to be appreciated that the system components may be connected by any real-time distributed network, including, for example, the Internet, dedicated data lines, wireless, satellite, voice response, and Personal Data Assistant networks or any other suitable form of data communications. Appointments 678 and schedule configuration data 630 travel through these connections.

Using the above components, the present invention provides a method and apparatus to receive multiple requests from End Users 320 to view a registered Service Provider's service (appointment/reservation) schedules stored at the Central Controller 300, displaying in real-time, a listing of available appointment/reservation times for a desired service, utilizing the displayed available time listing to secure an appointment/reservation with the Service Provider 350, and receiving a confirmation or rejection from the Central Controller 300 in response to the schedule request. Through the method and apparatus of the present disclosure, End Users 320 can efficiently schedule appointments/reservations with a plurality of registered Service Providers in real-time without the need for human intervention. That is, without the necessity of confirming e-mails (i.e., where a person has to type and transmit the e-mail), phone calls, or faxes, etc.

FIG. 2 illustrates an exemplary Service Provider interface 330 and End User interface 310. Interfaces 310 and 330 are preferably identical in fundamental construction and operation. As discussed above, there can be any number of Service Provider interfaces 330 and End User interfaces 310 linked up to one Central Controller 300. In a preferred embodiment, interfaces 310 and 330 are embodied in FIG. 2 as a laptop (or desktop) such as an IBM™-compatible PC or an Apple Macintosh™, running appropriate software. In alternate embodiments, interfaces 310 and 330 may be, for example, a wireless Palm Pilot TM, a CE Device or a cell phone.

Referring to FIG. 2, interfaces 310 and 330 include a central processing unit (CPU) 205, random access memory (RAM) 215, and read only memory (ROM) 220. CPU 205 processes and coordinates all of the components of the computer. CPU 205 is preferably an industry standard server grade CPU, such as an Intel Pentium. Equivalent processors include microprocessors manufactured by Motorola, Inc. or microprocessors manufactured by Sun Microsystems, Inc. In alternate embodiments, multiple CPUs may be used to speed the processing of requests from End Users 320 and Service Providers 350. ROM 220 is used to store at least some of the program instructions that are to be executed by the CPU 205. The use of a CPU in conjunction with ROM, RAM, and a clock circuit is well known to those skilled in the art of CPU-based electronic circuit design.

Interfaces 310 and 330 also include an Operating System 210, a User Input Interface 225, Internet Browsing Software 235, Data Storage Device 240, and Network Interface 245. Operating System 210 is software that hosts the file system and applications installed on the computer while also managing the input/output of the CPU 205, the usage of installed memory, RAM 215, and network connections from the Network Interface 245. RAM 215 is the inline memory that operating system and software applications use to operate. The amount of RAM 215 should be maximized to increase performance of the Internet Browsing Software 235. ROM 225 is the primary memory for the CPU 205 and also serves to store instructions to direct the computer to load the Operating System 210. ROM 225 is optimized for the CPU 205.

Network Interface 245 is the gateway to communicate with other End Users 320 and Service Providers 350 through respective End User interface 310 and Service Provider interface 330. Network Interface 245 also identifies the End User Computer 305 and Service Provider Computer 340 to the network, receives data from the network, and allows End Users 320 and Service Providers 350 to perform requests, transmit, and receive data to and from the network. The Network Interface 245 must be compatible with the Operating System 210 and CPU 205. Network Interface 245 supports modems at a range of baud rates from 1200 upward, but may combine such inputs into a TI or T3 line if more bandwidth is required. In a preferred embodiment, network interface 245 is connected with the Internet and/or any of the commercial online services such as Mindspring™, America Online™, or CompuServe™ allowing End Users 320 and Service Providers 350 access from a wide range of online connections.

Network Browsing Software module 235 refers to the software that is used to browse the Internet, execute requests for network resources, and view content. This software is readily available as a free download from either the Netscape Corporation or Microsoft. Module 235 must be compatible with the Operating System 210.

The Data Storage Device 240, can be any form of hardware based permanent readable/writable mass storage media either internal or external to the computer. Examples include, hard disks, Read Writable CD, optical storage units, and flash memory. Device 240 must be compatible with the Operating System 210 and the CPU 205. The User Input Interfaces 225, can be any form of hardware based device that allows the user to input information into the computer. Examples include active matrix displays, vacuum tube based video monitors, keyboards, mice, touch screens, telephones, etc.

FIG. 3 is a block diagram of a preferred Central Controller 300. Central Controller 300 operates as a primary server, both receiving and transmitting communications with End User Interface 310 and Service Provider Interface 330. A “Server” type computer capable of simultaneously handling both multiple network connections and multiple simultaneous database transactions may be used as Central Controller 300. Central Controller 300 may be, for example, a Sun Microsystems Enterprise 420R, a Dell PowerEdge 4400, or the like.

The Central Controller 300 includes a CPU 305, RAM 315, ROM 322, and a clock circuit 325. Central Controller 300 includes an Operating System 310, Random Access Memory (RAM) 315, and Read Only Memory (ROM) 322. The ROM 322 is used to store at least some of the program instructions that are to be executed by the CPU 305. A Clock Circuit 325 provides a clock signal, which is required by the CPU 305 and the Application Software module 352. The use of a CPU in conjunction with ROM, RAM, and a clock circuit is well known to those skilled in the art of CPU-based electronic circuit design.

The Central Controller 300 also includes a Network Interface 332, Network Request Handler/Fulfillment Software module 335, Application Software module 352, and a Data Storage Device 355.

The Network Request Handler/Fulfillment Software module 335 processes incoming requests from the Network Interface 332, hands off the processed request to the Application Software module 352 and returns the result to the Network Interface 332. The Network Request Handler/Fulfillment Software module 335 preferably is embodied as a “Web Server” compatible with Operating System 312.

Application Software module 352 embodies the object code of the invention that fulfills the request received from the Network Request Handler/Fulfillment software module 335. It provides all necessary logic required to move data into and out of the various databases stored in the data storage device 355 and process the data in a usable format for consumption by the End User and the Service Provider 350. The functions of the Application Software module 352 are described below.

Data Storage Device 355 is preferably any form of mass storage device configured to read and write database type data maintained in a file store (e.g., a magnetic disk data storage device). Of course, it will be readily appreciated that Data Storage Device 355 may be geographically dispersed and coupled via a network architecture. There is no positive requirement that Data Storage Device 355 be maintained in one facility. The implementation of local and wide-area database management systems to achieve the functionality of Data Storage Device 355 will be readily understood by those skilled in the art of computer technologies.

It is required that Data Storage Device 355 be compatible with the Operating System 312 and the CPU 305. Database management software stored within Data Storage Device 355 manages the relational access and storage of data received from Application Software module 352, and must also be compatible with the Operating System 312.

Stored within the Data Storage Device 355 are databases which are required for the operation of the invention. These databases are, in particular, an END USER DATABASE 360; a SERVICE PROVIDER DATABASE 365; a RESOURCE DATABASE 370; a SERVICE DATABASE 375; an APPOINTMENT DATABASE 380; RESOURCE CACHE DATABASE 385; APPOINTMENT/RESOURCE MAPPING DATABASE 390; and SERVICE/RESOURCE MAPPING DATABASE 395.

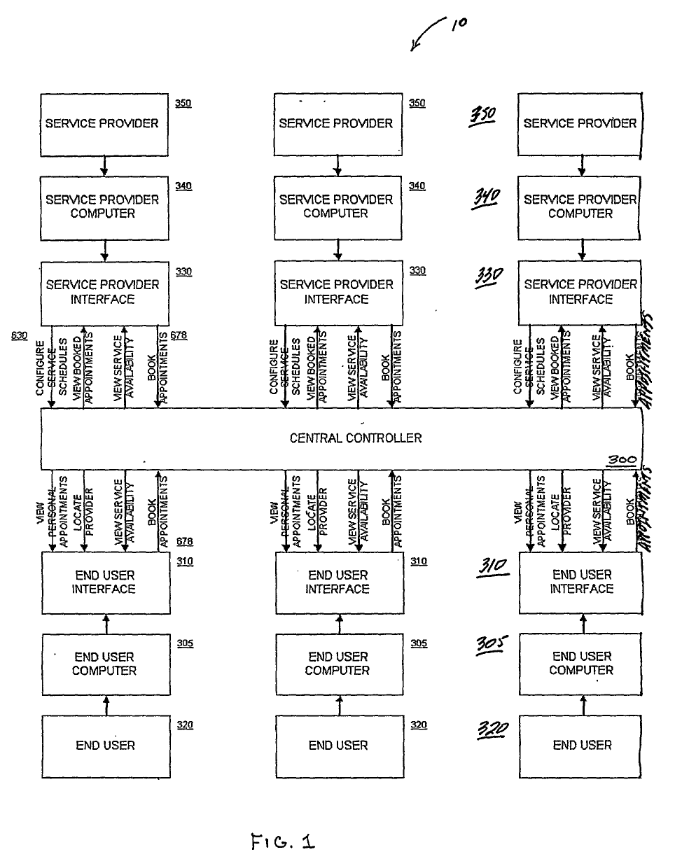

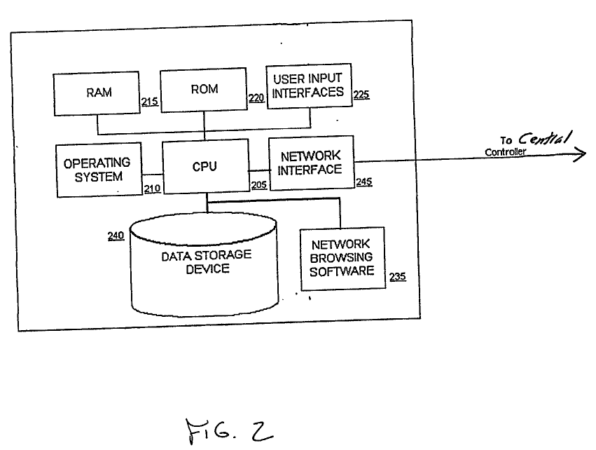

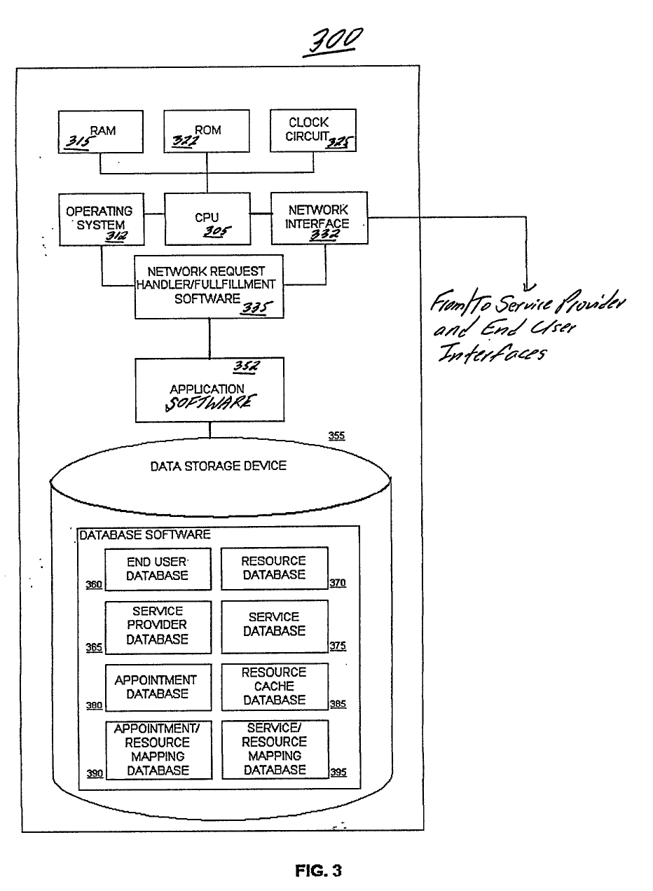

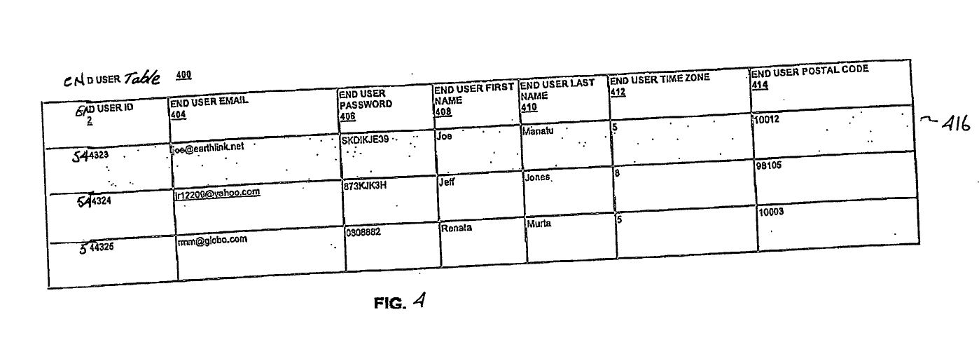

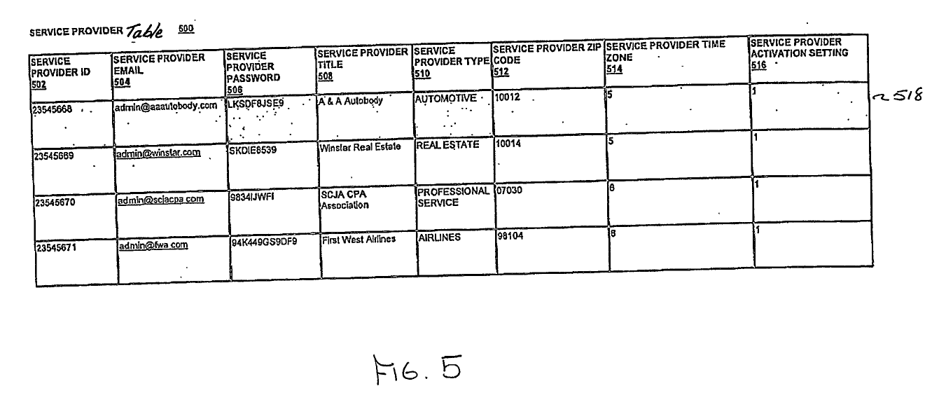

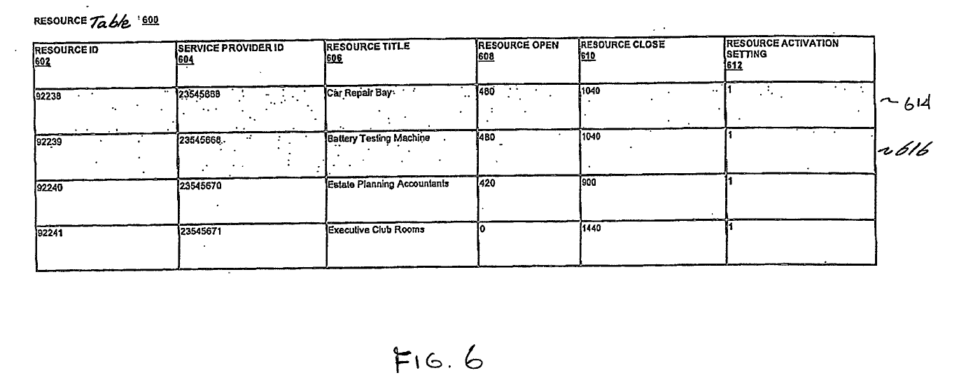

These databases are managed and maintained in a relational manner by the database management software, such as the ORACLE 8i Database Management System. The creation of such databases and the management and manipulation of the same will be readily understood by those skilled in the art of database management systems and, especially, relational database management systems. The databases stored within Data Storage Device 355 are described more fully below with reference to FIGS. 4-11.

The aforementioned and described systems shown in FIGS. 1-3 are merely illustrative of preferred embodiments of systems and components that may be used to carry out the functions and operations of the present invention.

The following paragraphs describe preferred embodiments of the databases that are used in the present invention to allow users to schedule appointments/reservations with a plurality of diverse Service Providers. The databases depicted in FIGS. 4-8 are intended to be operational in a computerized database management system of a data processing or automatic data processing system adapted to manage table relationships established by common fields, proper table joins and related mapping tables (not necessarily depicted in the diagrams).

In particular, a relational database management system is well suited to manage the flow of information with a system such as system 10 (FIG. 1) and the processing of data and tables illustrated in FIGS. 4-8 is one like ORACLE 8i produced by the Oracle Corporation. Of course, many changes and alterations may be made to such tables to effectuate certain functionality depending on particular design and implementation details. Such changes and alterations will be apparent to those skilled in the art of computer programming and database management system design and implementation. Moreover, the use of a database management system such as the ORACLE 8i system will be readily apparent to those skilled in the art of database design and implementation.

Referring now to FIG. 4, therein depicted is an END USER Table 400 stored within End User Database 360. END USER Table 400 is preferably used in a relational arrangement whereby Table 400 is related to other tables in the particular database management system by way of common columns or table fields. In any case, END USER Table 400 is maintained in Data Storage Device 355 preferably as one or more physical disks. The columns indicate the necessary fields stored in End User Table 400 and the rows contain the data corresponding to individual records stored in End User Table 400. Each record of End User Table 400 represents information pertaining to End Users 320 who have confirmed appointments/reservations with the system, and includes the following information elements: END USER ID 402; END USER EMAIL 404; END USER PASSWORD 406; END USER FIRST NAME 408; END USER LAST NAME 410; END USER TIME ZONE 412; and END USER POSTAL CODE 414. In actual implementation, other fields may be added to store more detailed information related to each end user or for database management system purposes, or other tables may be added to manage End User data. The addition of such fields and columns will be readily appreciated by those skilled in the art of database management system design and implementation. The above data fields are obtained from an end user at any point before the end user schedules an appointment/reservation.

END USER ID 402 stores each End User's unique system identifier; END USER EMAIL 404 stores each End User's unique e-mail address; END USER PASSWORD 406 stores each End User's unique system password; END USER FIRST NAME 408 stores each End User's first name; END USER LAST NAME 410 stores each End User's last name; END USER TIME ZONE 412 stores each End User's location time zone; and END USER POSTAL CODE 414 stores each End User's location zip code.

It should be understood that the column structure shown in table 400 is merely exemplary and not intended to restrict the present invention; those skilled in the art of database management system design and implementation may make many changes including the addition or deletion of fields or columns to effectuate particular system functionality and the like.

Table 400 shows three records containing information about three different End Users 320. Using the first row 416 as an example illustrating the values of each of the fields in the END USER DATABASE 400: “544323” is the END USER ID 402; joe@earthlink.net is the END USER EMAIL 404; “SKDIKJE39” is the END USER PASSWORD 406; “Joe” is the END USER FIRST NAME 408; “Manatu” is the END USER LAST NAME 410; and “5” is the END USER TIME ZONE 412 corresponding to (GMT-5:00) Eastern Time (US & Canada) and derived from END USER POSTAL CODE 414, which is “10012”.

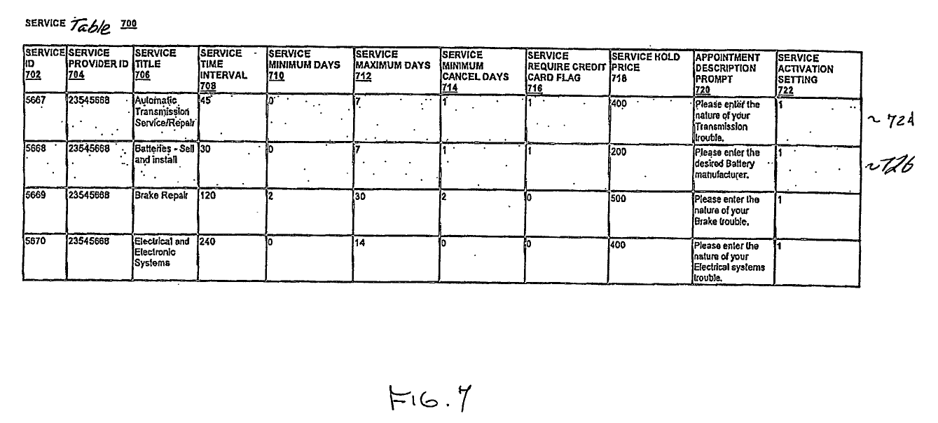

Referring now to FIG. 5, therein depicted is a SERVICE PROVIDER Table 500 stored within SERVICE PROVIDER DATABASE 365. SERVICE PROVIDER Table 500 is shown as having a column and row arrangement. Each record of Service Provider Table 500 represents information pertaining to registered Service Providers that provide their service schedules on the system. The information included in table 500 is preferably obtained from a Service Provider 350 at the registration stage, but preferably obtained prior to a Service Provider 350 being allowed to present service schedules to End Users 320. Table 500 preferably includes the following eight information elements: SERVICE PROVIDER ID 502; SERVICE PROVIDER EMAIL 504; SERVICE PROVIDER PASSWORD 506; SERVICE PROVIDER TITLE 508; SERVICE PROVIDER TYPE 510; SERVICE PROVIDER ZIP CODE 512; SERVICE PROVIDER TIME ZONE 514; and SERVICE PROVIDER ACTIVATION SETTING 516. In actual implementation, other fields may be added to store more detailed information related to each Service Provider 350 or for database management system purposes, or other tables may be added to manage Service Provider data. The addition of such information fields will be readily appreciated by those skilled in the art of database management system design and implementation.

SERVICE PROVIDER ID 502 stores each Service Provider's unique system identifier; SERVICE PROVIDER EMAIL 504 stores each Service Provider's unique email; SERVICE PROVIDER PASSWORD 506 stores each Service Provider's unique password; SERVICE PROVIDER TITLE 508 stores each Service Provider's business name; SERVICE PROVIDER TYPE 510 stores each Service Provider's type of business; SERVICE PROVIDER ZIP CODE 512 stores each Service Provider's zip code; SERVICE PROVIDER TIME ZONE 514 stores each Service Provider's time zone; and SERVICE PROVIDER ACTIVATION SETTING 516 stores each Service Provider's activation setting allowing each Service Provider 350 to indicate to the system 10 when they wish to begin providing their schedules online.

Table 500 shows three records containing information about three different Service Providers 350. Using the first row 518 as an example illustrating the values of each of the fields in the SERVICE PROVIDER DATABASE 500: “23545668” is the SERVICE PROVIDER ID 502; “admin@aaautobody.com” is the SERVICE PROVIDER EMAIL 504; “LKSDF8JSE9” is the SERVICE PROVIDER PASSWORD 506; “A & A Autobody” is the SERVICE PROVIDER TITLE 508; “AUTOMOTIVE” is the SERVICE PROVIDER TYPE 510; “20021” is the SERVICE PROVIDER ZIP CODE 512; “5” is SERVICE PROVIDER TIME ZONE 514 derived from the SERVICE PROVIDER ZIP CODE; and “1” is the SERVICE PROVIDER ACTIVATION SETTING 516 indicating that the Service Provider 350 is available to End Users 320.

It should be understood that the column structure shown in table 500 is merely exemplary and not intended to restrict the present invention; those skilled in the art of database management system design and implementation may make many changes including the addition or deletion of fields or columns to effectuate particular system functionality and the like.

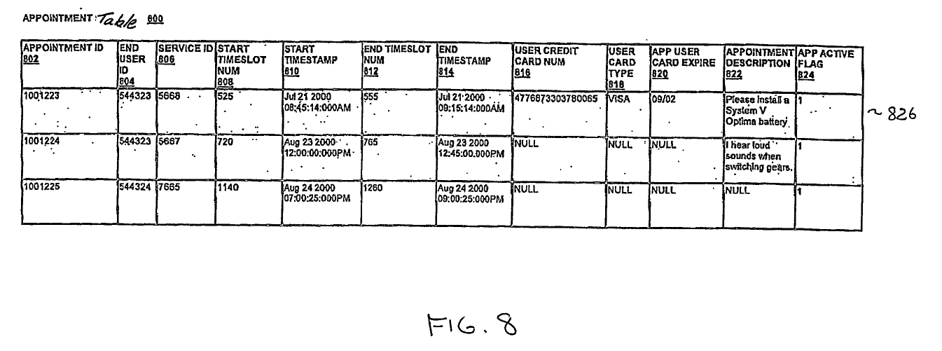

Referring now to FIG. 6, therein depicted is a RESOURCE Table 600 stored within RESOURCE DATABASE 370. RESOURCE Table 600 is shown as having a column and row arrangement. Each record of Resource Table 600 represents a Service Provider's capacity for providing services to End Users 320. The information included in Resource table 600 is preferably obtained from a Service Provider 350 at the registration stage, but preferably obtained prior to a Service Provider 350 being allowed to present service schedules to End Users 320. Resource Table 600 preferably includes the following six information elements: RESOURCE ID 602; SERVICE PROVIDER ID 604; RESOURCE TITLE 606; RESOURCE OPEN 608; RESOURCE CLOSE 610; and RESOURCE ACTIVATION SETTING 612. In actual implementation, other fields may be added to store more detailed information related to each Resource or for database management system purposes, or other tables may be added to manage Resource data. The addition of such information fields will be readily appreciated by those skilled in the art of database management system design and implementation.

RESOURCE ID 602 stores each Resource's unique system identifier; SERVICE PROVIDER ID 604 relates each resource back to the Service Provider that owns the Resource and stores that Service Provider's unique system identifier; RESOURCE TITLE 606 stores the title of the Resource; RESOURCE OPEN 608 stores the minute of the day between 12:01 am and 23:59 pm that the resource becomes available for providing a service; RESOURCE CLOSE 610 stores the minute of the day between 12:01 am and 23:59 pm that the resource is no longer available for providing a service; and RESOURCE ACTIVATION SETTING 612 stores the activation setting of the resource allowing the Service Provider to deactivate a resource thereby preventing its consumption by End Users 320.

Table 600 shows four records containing information about four different Resources. Using the first row 614 as an example illustrating the values of each of the fields in the RESOURCE DATABASE 600: “92238” is the RESOURCE ID 602; “23545668” is the SERVICE PROVIDER ID 604 relating this Resource to the Service Provider titled “A & A Autobody”; “Car Repair Bay” is the RESOURCE TITLE 606; “480” is the RESOURCE OPEN 608 indicating that this Resource is open to provide services at 8 am; “1040” is the RESOURCE CLOSE 610 indicating that this Resource is no longer open to provide services at 5:20 pm; and “1” is the RESOURCE ACTIVATION SETTING 612 indicating that the Resource is available to End Users 320.

It should be understood that the column structure shown in table 600 is merely exemplary and not intended to restrict the present invention; those skilled in the art of database management system design and implementation may make many changes including the addition or deletion of fields or columns to effectuate particular system functionality and the like.

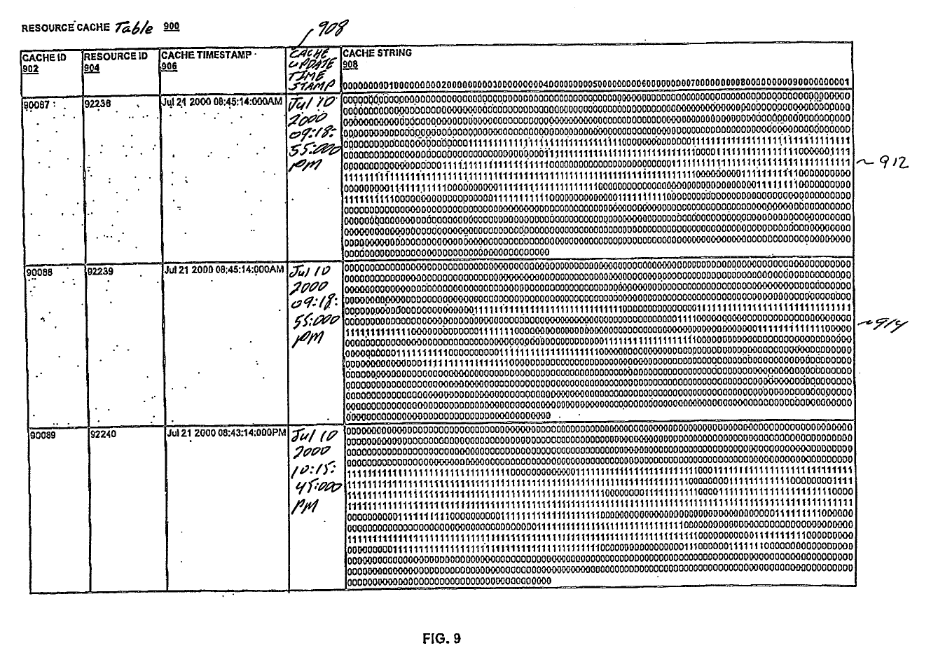

Referring now to FIG. 7, therein depicted is a SERVICE Table 700 stored within SERVICE DATABASE 375. SERVICE Table 700 is shown as having a column and row arrangement. Each record of SERVICE Table 700 represents a Service Provider's list of Services that its resources can provide to End Users 320. The information included in SERVICE Table 700 is preferably obtained from a Service Provider at the registration stage, but preferable obtained prior to a Service Provider 350 being allowed to present service schedules to End Users 320. Table 700 preferably includes the following eleven information elements: SERVICE ID 702; SERVICE PROVIDER ID 704; SERVICE TITLE 706; SERVICE TIME INTERVAL 708; SERVICE MINIMUM DAYS 710; SERVICE MAXIMUM DAYS 712; SERVICE MINIMUM CANCEL DAYS 714; SERVICE REQUIRE CREDIT CARD FLAG 716; SERVICE HOLD PRICE 718; APPOINTMENT DESCRIPTION PROMPT 720; and SERVICE ACTIVATION SETTING 722. In actual implementation, other fields may be added to store more detailed information related to each Service Provider or for database management system purposes, or other tables may be added to manage Service data. The addition of such information fields will be readily appreciated by those skilled in the art of database management system design and implementation.

SERVICE ID 702 stores each service's unique identifier; SERVICE PROVIDER ID 704 relates each resource back to the Service Provider that owns the Resource and stores that Service Provider's unique system identifier; SERVICE TITLE 706 stores the title of the service; SERVICE TIME INTERVAL 708 stores the length of time in minutes that a service requires to complete; SERVICE MINIMUM DAYS 710 stores the number of days ahead of time that a Service can be reserved (0 means that the Service can be reserved on the same day); SERVICE MAXIMUM DAYS 712 stores the number of days in the future that a Service can be reserved (0 means that the Service can be reserved any number of days into the future); SERVICE MINIMUM CANCEL DAYS 714 stores the number of days before the reservation that the reservation can be canceled by the end user (0 means that the reservation can be canceled on the same day of the reservation); SERVICE REQUIRE CREDIT CARD FLAG 716 stores the setting of the Service allowing the Service Provider to require a credit card hold when an End User reserves a Service; SERVICE HOLD PRICE 718 stores the amount that the service dealer requires to hold a reservation if it requires a credit card hold; APPOINTMENT DESCRIPTION PROMPT 720 stores an optional question prompting the user to enter a description along with their reservation; and the SERVICE ACTIVATION SETTING 722 stores the activation setting of the Service allowing the Service Provider to deactivate a service thereby preventing its consumption by End Users 320 Table 700 shows four records containing information about four different Services. Using the first row 724 as an example illustrating the values of each of the fields in the SERVICE DATABASE 700: “5667” is the SERVICE ID 702; “23545668” is the SERVICE PROVIDER ID 704 relating this Resource to the Service Provider titled “A & A Autobody”; “Automatic Transmission Service/Repair” is the SERVICE TITLE 706; “45” is the SERVICE TIME INTERVAL 708; “0” is the SERVICE MINIMUM DAYS 710; “7” is the SERVICE MAXIMUM DAYS 712; “1” is the SERVICE MINIMUM CANCEL DAYS 714 indicating that End Users 320 must enter their a credit card information to reserve a service; “1” is the SERVICE REQUIRE CREDIT CARD FLAG 716; “400” is the SERVICE HOLD PRICE 718 indicating that if a credit card is required, the End User's credit card must have at least $400 clearance between the current balance and the End User credit card's credit limit; “Please enter the nature of your Transmission trouble” is the APPOINTMENT DESCRIPTION PROMPT 720 prompting the user to enter a description of the transmission relate trouble that prompted the need to reserve this Service; and “1” is the SERVICE ACTIVATION SETTING 722 indicating that the Service is available to End Users 320.

It should be understood that the column structure shown in table 700 is merely exemplary and not intended to restrict the present invention; those skilled in the art of database management system design and implementation may make many changes including the addition or deletion of fields or columns to effectuate particular system functionality and the like.

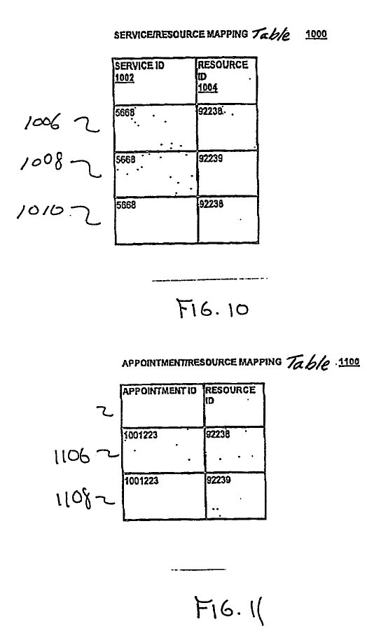

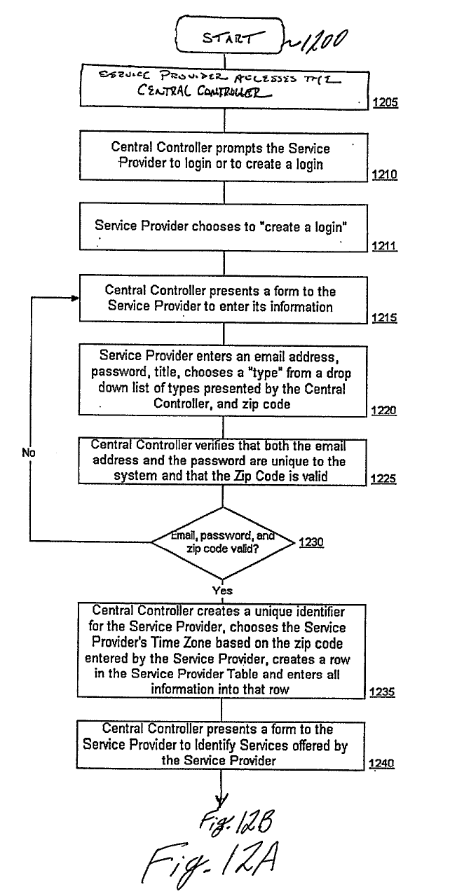

Referring now to FIG. 8, therein depicted is a APPOINTMENT Table 800 stored within APPOINTMENT DATABASE 380. APPOINTMENT Table 800 is shown as having a column and row arrangement. Each record of Appointment Table 800 represents the reservation of a specific service between a Service Provider 350 and an End User 320. The information included in Table 800 is preferably obtained from a Service Provider at the registration stage, but preferably obtained prior to a Service Provider 350 being allowed to present service schedules to End Users 320. Table 800 preferably includes the following twelve information elements: APPOINTMENT ID 802; END USER ID 804; SERVICE ID 806; START TIMESLOT NUM 808; START TIMESTAMP 810; END TIMESLOT NUM 812; END TIMESTAMP 814; USER CREDIT CARD NUM 816; USER CARD TYPE 818; APP USER CARD EXPIRE 820; APPOINTMENT DESCRIPTION 822; and APP ACTIVE FLAG 824. In actual implementation, other fields may be added to store more detailed information related to each Service Provider or for database management system purposes, or other tables may be added to manage Appointment data. The addition of such information fields will be readily appreciated by those skilled in the art of database management system design and implementation.

APPOINTMENT ID 802 stores each Appointment's unique system identifier; END USER ID 804 relates each appointment back to the End User that created or is otherwise related to this appointment and stores that End User's unique system identifier; SERVICE ID 806 relates each Appointment back to the service that is to be provided during the Appointment's time frame and stores that Service's unique system identifier; START TIMESLOT NUM 808 stores the start minute of the Appointment; START TIMESTAMP 810 stores month, day, year, hour, minute, second, and millisecond that the appointment starts; END TIMESLOT NUM 812 stores the end minute of the Appointment; END TIMESTAMP 814 stores month, day, year, hour, minute, second, and millisecond that the appointment ends; USER CREDIT CARD NUM 816 stores the End User's credit card number if the Service Provider requires a credit card hold for the reservation of this specific Service; USER CARD TYPE 818 stores the End User's credit card type if the Service Provider requires a credit card hold for the reservation of this specific Service; APP USER CARD EXPIRE 820 stores the End User's credit card expiration date if the Service Provider requires a credit card hold for the reservation of this specific Service; APPOINTMENT DESCRIPTION 822 stores the End User's response to APPOINTMENT DESCRIPTION PROMPT 718; and APP ACTIVE FLAG 824 stores the status of the appointment. Appointment status includes “active” and “canceled”.

Table 800 shows three records containing information about three different Appointments. Using the first row 826 as an example illustrating the values of each of the fields in the APPOINTMENT DATABASE 800: “1001223” is the APPOINTMENT ID 802; “544323” is the END USER ID 804 relating this Appointment to the Service User whose END USER EMAIL 404 is “joe@earthlink.net”; “5668” is the SERVICE ID 806 relating this Appointment to the Service titled “Batteries—Sell and install”; “525” is the START TIMESLOT NUM 808 indicating that this Appointment begins at the 525^{th} minute of the day or 8:45 am;, “Jul. 21, 2000 08:45:14:000 AM” is the START TIMESTAMP 810 indicating the month, day, year, hour, minute, second, and millisecond that the Appointment begins; “555” is the END TIMESLOT NUM 812 indicating that this Appointment ends at the 555^{th} minute of the day or 9:15 am; “Jul. 21, 2000 09:15:14:000 AM” is the END TIMESTAMP 814 indicating the month, day, year, hour, minute, second, and millisecond that the Appointment ends; “4776873303780065” is the USER CREDIT CARD NUM 816 indicating that the Service Provider requires a credit card hold for reserving this service; “VISA” is the USER CARD TYPE 818; “09/02” is the APP USER CARD EXPIRE 820 indicating that the user's VISA card expires September of 2002; “Please install a System V Optima battery” is the End User's response to APPOINTMENT DESCRIPTION PROMPT 822 “Please enter the desired Battery manufacturer” referenced by the SERVICE ID 806; and “1” is the APP ACTIVE FLAG 824 indicating that this appointment is still valid and has not been canceled.

It should be understood that the column structure shown in table 800 is merely exemplary and not intended to restrict the present invention; those skilled in the art of database management system design and implementation may make many changes including the addition or deletion of fields or columns to effectuate particular system functionality and the like.

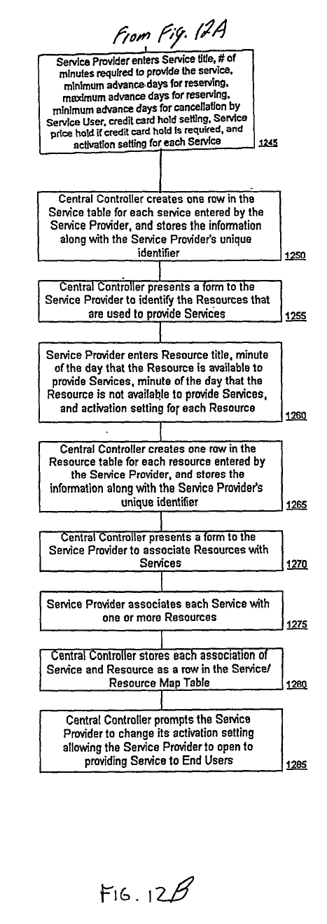

Referring now to FIG. 9, therein depicted is a RESOURCE CACHE Table 900 stored within RESOURCE CACHE DATABASE 385. RESOURCE CACHE Table 900 is shown as having a column and row arrangement. Each record of the Resource Cache Table 900 represents the available and reserved time slots for a given Resource on a given day. The information included in Table 900 is managed by the APPLICATION SOFTWARE module 352. As End Users 320 interact with the APPLICATION SOFTWARE module 352 and reserve Resources, the APPLICATION SOFTWARE module 352 summarizes this information and stores it in the RESOURCE CACHE Table 900 for the purposes of fast access.

Table 900 preferably includes the following four information elements: CACHE ID 902; RESOURCE ID 904; CACHE TIMESTAMP 906; CACHE UPDATE TIMESTAMP 908; and CACHE STRING 910. In actual implementation, other fields may be added to store more detailed information related to each Service Provider or for database management system purposes, or other tables may be added to manage Resource Cache data. The addition of such information fields will be readily appreciated by those skilled in the art of database management system design and implementation.

CACHE ID 902 stores each Resource Cache unique system identifier; RESOURCE ID 904 relates each Resource Cache row back to the Resource which information is being managed by the Resource Cache and stores that Resource's unique system identifier; CACHE TIMESTAMP 906 stores the day that the Resource Cache pertains to; CACHE UPDATE TIMESTAMP 908 stores the database time that the Resource Cache row is updated; and CACHE STRING 910 stores the available and reserved timeslots for the given RESOURCE ID 904 on the given CACHE TIMESTAMP 906.

Table 900 shows three records containing information about three different Resource Caches. Using the first row 912 as an example illustrating the values of each of the fields in the RESOURCE CACHE DATABASE 900: the CACHE ID field 902 contains the entry “90087”; the RESOURCE ID 904 field contains the entry “92238”; which is a relational field relating “92238” to the Resource titled “Car Repair Bay”; “Jul. 21, 2000 08:45:14:000 AM” is the CACHE TIMESTAMP 906 indicating that this Resource Cache pertains to Jul. 21, 2000; “Jul. 10, 2000 09:18:55:000 PM” is the CACHE UPDATE TIMESTAMP 908 indicating that this row was last updated on Jul. 10, 2000 at 9:18 PM; and a binary string, referred to as the CACHE STRING 910, where each string element is either a binary “0” or “1”. The string's bit length is 1440 representing each minute of a 24-hour day. The string contains a “0” value for each unreserved minute of the day, and correspondingly, the string contains a “1” value for every minute that has been reserved by an end user indicating that this Resource is reserved during the following times: 8:25 am 9:15 am, 9:30 am-10:00 am, 10:40 am-11:10 am, 11:15 am-11:30 am, 11:37 am-11:40 am, 12:00 pm-12:20 pm, 12:46 pm-1:20 pm, 1:21 pm-2:30 pm, 2:40 pm-2:50 pm, 3:00 pm-3:10 am, 3:30 pm-3:40 pm, and 3:55 pm-4:05 pm.

It should be understood that the column structure shown in table 900 is merely exemplary and not intended to restrict the present invention; those skilled in the art of database management system design and implementation may make many changes including the addition or deletion of fields or columns to effectuate particular system functionality and the like.

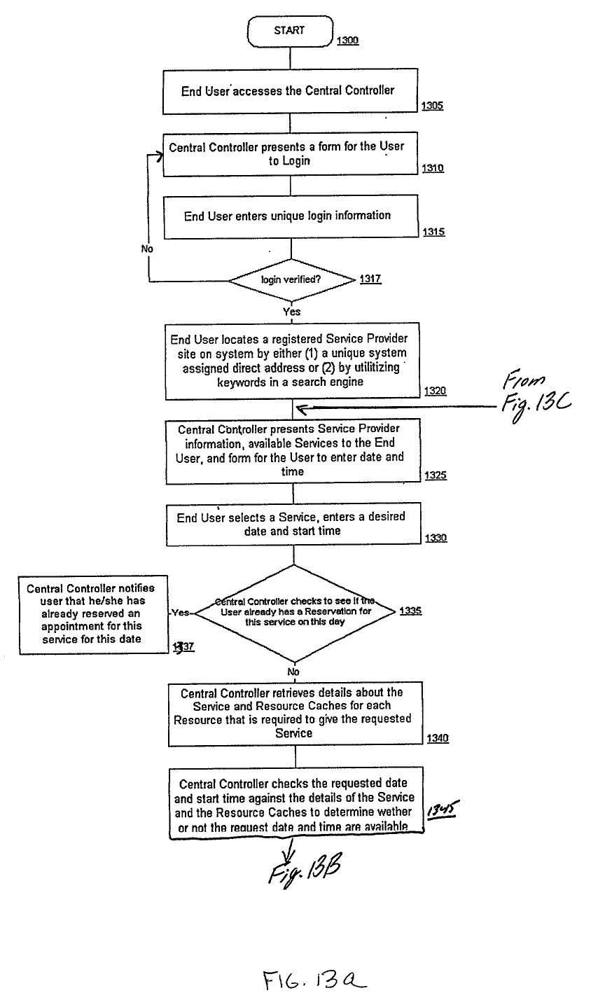

Referring now to FIG. 10, therein depicted is a SERVICE/RESOURCE MAPPING Table 1000 stored within SERVICE/RESOURCE MAPPING DATABASE 395. SERVICE/RESOURCE MAPPING Table 1000 is shown as having a column and row arrangement. Each record of SERVICE/RESOURCE MAPPING Table 1000 stores which resources are mapped to a single service. The information included in Table 1000 is preferably obtained from a Service Provider at the registration stage, but preferably obtained prior to a Service Provider 350 being allowed to present service schedules to End Users 320. Table 1000 preferably includes the following two information elements: SERVICE ID 1002; and RESOURCE ID 1004.

SERVICE ID 1002 indicates which service is being mapped to which Resource specified by RESOURCE ID 1004 and stores that service's unique system identifier; and RESOURCE ID 1004 indicates which resource is being mapped to which Service specified by SERVICE ID 1002 and stores that resource's unique system identifier.

Table 1000 shows three records 1006, 1008, 1010 containing information about three mappings between the Service Table 700 and the Resource Table 600. Using the first row 1006 as an example illustrating the values of each of the fields in the SERVICE/RESOURCE MAPPING Table 1000, the first entry of row 1006, i.e., “5668”, is the SERVICE ID 1002 entry. This field is a relational field which maps to the service database 700 identifying the service titled “Batteries—Sell and install”. The second entry of row 1006, i.e., “92238”, represents an entry of the RESOURCE ID 1004 field. This entry represents a resource which is mapped to the identified service, i.e., “Batteries—Sell and install”. The entry “92238” is also a relational field which when mapped to the RESOURCE DATABASE 370 identifies the resource titled “Car Repair Bay”.

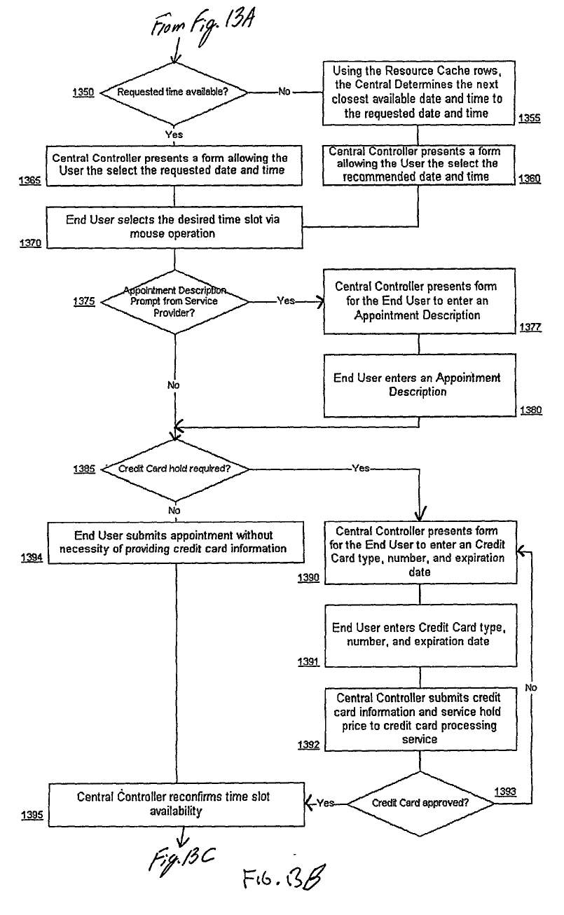

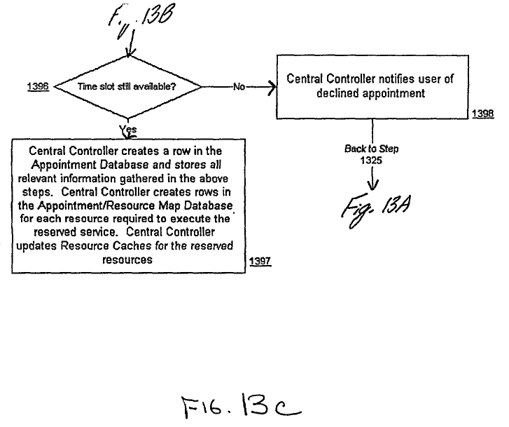

Referring now to FIG. 11, therein depicted is a APPOINTMENT/RESOURCE MAPPING Table 1100 stored within APPOINTMENT/RESOURCE MAPPING Database 390. APPOINTMENT/RESOURCE MAPPING Table 1100 is shown as having a column and row arrangement. Each record of Appointment/Resource Mapping Table 1100 stores which resources are mapped to a single appointment. The information included in Table 1100 is preferably obtained from a Service Provider 350 at the registration stage, but preferably obtained prior to a Service Provider 350 being allowed to present service schedules to End Users 320. Table 1100 preferably includes the following two information elements: APPOINTMENT ID 1102; and RESOURCE ID 1104.

APPOINTMENT ID 1102 indicates which appointment is being mapped to which resource specified by RESOURCE ID 1104 and stores that appointment's unique system identifier; and RESOURCE ID 1104 indicates which resource is being mapped to which appointment specified by APPOINTMENT ID 1102 and stores that appointment's unique system identifier.

Table 1100 shows two records 1106, 1108 containing information about mappings between the Appointment Table 800 and the Resource Table 600. Using the first row 1106 as an example, “1001223” is the value shown in the APPOINTMENT ID 1102 field which, when mapped back to the appointment table, defines an appointment to be serviced on “Jul. 21, 2000 08:45:14:000 AM” for the Service titled “Batteries—Sell and install” to the User whose email is “joe@earthlink.net”. The value shown in the RESOURCE ID 1104 field is “92238”, which defines the resource to be mapped to the appointment, “1001223”. The value “92238”, when mapped back to the Resource Table 600 defines the resource titled “Car Repair Bay”.

The aforementioned discussions relate to the system architecture of the preferred embodiments and corresponding components of the present invention. Accordingly, it should be understood that the system 10 and Central Controller 300 shown in FIGS. 1 and 3, respectively, have been designed to operate and function together.

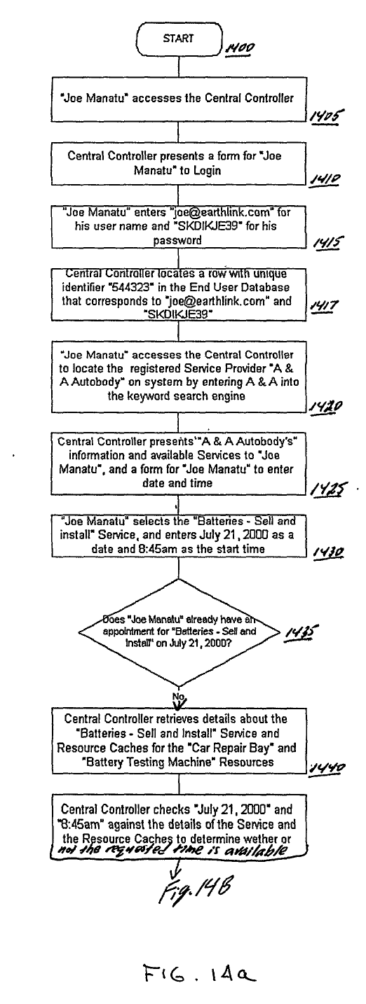

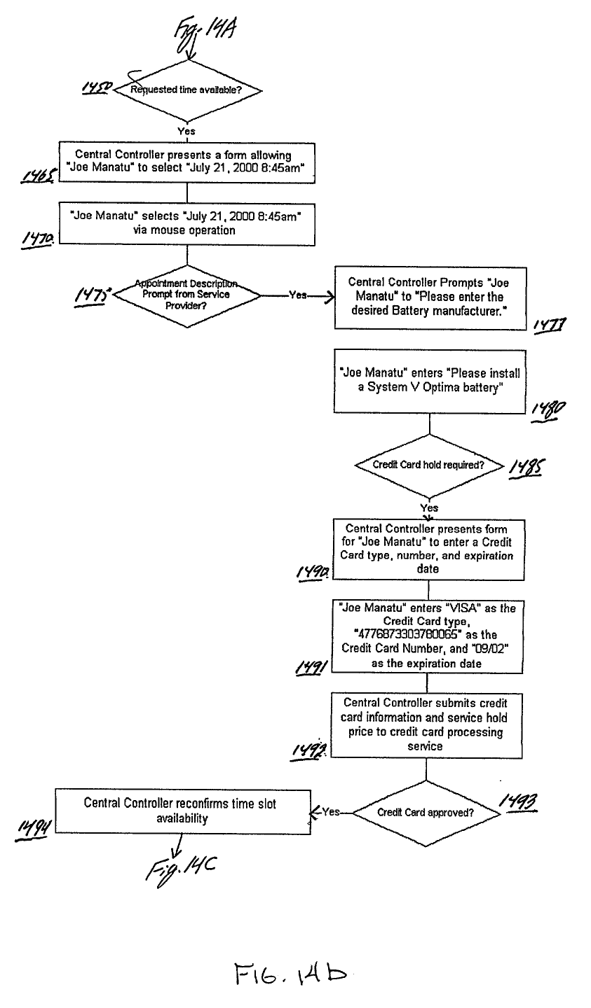

With reference to FIGS. 12 and 13, exemplary descriptions will now be provided as to the steps carried out by the system 10 to allow Service Providers 350 to register their unique resource models with the Central Controller 300 according to the present invention. These steps allow End Users 320 to schedule appointments/reservations and other schedule interactions with registered Service Providers 350 via the Central Controller 300, using the pre-registered services provided by the registered Service Providers 350. The descriptions pertaining to FIGS. 12 and 13 will be provided with regard to an embodiment whereby the communication network is the Internet.

II. Operational Aspects

FIG. 12 illustrates the steps of a preferred process by which a Service Provider 350 interacts with the Central Controller 300 to input and configure data regarding Services offered by the Service Provider 350. The Service Provider 350 will use these steps to define the business rules that govern how the Services can be electronically reserved by End Users 320. The computer programming necessary to carry out many of the functions stated below will be readily apparent to those skilled in the art of computer programming and will not require undue design and implementation effort. The flowcharts of FIGS. 12 and 13 along with the discussions of the same are sufficient and adequate to enable one skilled in the art of computer programming to make and use the present invention.

Referring now to FIG. 12, processing starts at Step 1200, and proceeds to Step 1205 where the Service Provider 350 accesses the Central Controller 300 via the Internet. In Step 1210, Central Controller 300 prompts the Service Provider 350 to login or to create a login. In Step 1211, Service Provider 350 chooses to “create a login”. In Step 1215, Central Controller 300 presents a form to the Service Provider 350 to enter its information. In Step 1220, Service Provider 350 enters an email address, password, title, chooses a “type” from a drop down list of types presented by the Central Controller 300, and zip code. In Step 1225, Central Controller 300 verifies that both the email address and the password are unique to the system and that the zip code is valid. If this information is valid, then the Central Controller 300 allows the Service Provider 350 to proceed to Step 1235, otherwise, the Service Provider 350 must return to Step 1215 and re-enter this information. In Step 1235, Central Controller 300 creates a unique identifier for the Service Provider 350, chooses the Service Provider's Time Zone based on the zip code entered by the Service Provider 350, creates a row in the Service Provider Table 500 and enters all information into that row.

In Step 1240, Central Controller 300 presents a form to the Service Provider 350 to Identify Services offered by the Service Provider 350. Services for an automotive repair business might include transmission service and repair, or battery installation, etc., or at a supermarket might include delivering food. In Step 1245, the Service Provider 350 enters Service title, number of minutes required to provide the service, minimum advance days for reserving, maximum advance days for reserving, minimum advance days for cancellation by the End User, credit card hold setting, Service price hold if credit card hold is required, and activation setting for each service.

In Step 1250, Central Controller 300 creates one row in the Service Table 700 for each service entered by the Service Provider 350, and stores the information along with the Service Provider's unique identifier. In Step 1255, Central Controller 300 presents a form to the Service Provider 350 to identify the Resources that are used to provide Services. For the automotive services business, resources required to provide the Battery Install Service might include a service bay, a mechanic, and a Battery Testing machine. In Step 1260, Service Provider 350 enters Resource title, minute of the day that the Resource is available to provide Services, minute of the day that the resource is not available to provide Services, and activation setting for each resource.

In Step 1265, Central Controller 300 creates one row in the Resource Table 600 for each resource entered by the Service Provider 350, and stores the information along with the Service Provider's unique identifier. After creating the Service and the Resources, the Service Provider 350 must relate the two together. For example, the Battery Install Service would be related to one service bay, one mechanic, and one battery-testing machine. In Step 1270, Central Controller 300 presents a form to the Service Provider 350 to associate resources with services. In Step 1275, Service Provider 350 associates each service with one or more resources. In Step 1280, Central Controller 300 stores each association of service and resource as a row in the Service/Resource Mapping Table 1000. In Step 1285, Central Controller 300 prompts the Service Provider 350 to change its activation setting allowing the Service Provider 350 to open to provide service to End Users 320.

FIG. 13 provides a flow diagram that illustrates the steps of a preferred process by which an End User attempts to schedule an appointment/reservation, via the Central Controller 300, with one or more registered Service Providers 350. It is important to note that many of the steps depicted in FIG. 13 illustrate the sequence of operations carried out by the network such as system 10 as depicted in FIGS. 1 and 2. The computer programming necessary to carry out many of the functions stated below will be readily apparent to those skilled in the art of computer programming and will not require undue design and implementation effort.

Referring now to FIG. 13, processing starts at Step 1300, and proceeds to Step 1305 where the End User accesses the Central Controller 300 via the Internet. At Step 1310, it is necessary for the End User to have registered with the Central Controller 300 before scheduling an appointment; therefore, the End User is presented a form to login to the Central Controller 300. At Step 1315, End User enters his/her unique login information. Any unique combination of two character strings is adequate for this step. For the proposed embodiment, the End User's unique End User Email 404, and End User Password 406 is appropriate. At Step 1317, the Central Controller 300 verifies the entries from Step 1315 by searching End User Database 360 for a matching record that includes both the End User Email 404 and End User Password exactly as has been entered by the End User in Step 1315. If a matching record exists, then the process proceeds to Step 1317. If a row does not exist, then the End User is notified that the login information is incorrect and the process returns to Step 1310.

In Step 1320, the end user locates a desired Service Provider 350 on the system 10 using either a direct Internet address or by inputting appropriate keywords as part of a Search utilizing a Search Engine. In the case where a direct Internet address is used, a unique Internet address is assigned to each Service Provider 350 upon registration with the Central Controller 300. This unique Internet address can be entered by a End User directly in the address window of an Internet browser. Alternatively, the Internet address can be linked directly from any web page on the Internet.

Thereafter, processing proceeds to Step 1325, where after locating the Service Provider 350 in the Service Provider Database 365 at step 1320, the Central Controller 300 presents the Service Provider information including Title, address, and contact information, available Services which may be, for example, Battery—Sell and Install, Financial Advise, Algebra Tutoring, Conference Room Meeting, Delivery Bay for Unloading Goods, to the End User, and form for the End User to enter date and time. In Step 1330, the End User considers the information presented in Step 1325, selects a service, and enters a desired date and start time.

In Step 1335, the Central Controller 300 checks the Appointment Database 380 to determine whether or not the End User has already booked an appointment for the requested service on requested date. If an appointment is found, then in Step 1537, the Central Controller 300 notifies the End User that an appointment has already been made for the requested service on the requested date, and the user is not allowed to proceed. It is noted that Step 1337 could be removed from the application if the Service Provider 350 wishes to allow the End Users 320 to book more than one appointment for any given service on any given date. This step is mentioned to illustrate by example how the application can restrict users from abusing the system 10. If in Step 1335, the Central Controller 300 does not find an appointment, then the processing continues to Step 1340 where the Central Controller 300 retrieves the Resources required to provide the Service from the Service/Resource Mapping Database 395 and the Resource Caches from the Resource Cache Database 385 for the requested Date. The Central Controller 300 records each of the Resource Caches' Cache Update Timestamp 908 for use in Step 1410.

In Step 1345, the Central Controller 300, using standard software character matching mechanisms, such as regular expression string matching, scans the Resource Cache strings for each Resource Cache to determine whether or not each Resource is available during the time period requested by the End User. This is preferably accomplished as follows. Each Resource Cache string is 1440 characters long and represents a given resource for a given day. Each of the 1440 characters in the Resource Cache string represents one minute in a given day. Each character in the string may take one of two values, a binary “0” or “1”. If the resource is booked for a given minute, then the binary character for that minute will be “1”, otherwise if the resource is available for that minute, then the character for that minute will be “0”. If all of the Resources are available to provide the requested Service on the requested date and time, then processing continues to Step 1365. If not then processing branches to Step 1355.

It should be appreciated that Step 1345 is demonstrated using a single requested service for a single requested date and a single requested time. Step 1345 can be executed across multiple requested dates, multiple requested times, multiple requested Services or any combination thereof. In Step 1365, the Central Controller 300 notifies the user that the requested Service, date, and time is available and allows the user to select this approved appointment and continue.

In Step 1355, having determined that the requested service date and/or time are not available, the Central Controller 300, using the Resource Cache strings, determines the next closest available dates and times before and after the requested date and time. In Step 1360, the Central Controller 300 presents the next available dates and times for the requested service before and after the requested date and time and allows the user to select an approved appointment and continue.

In 1370, the End User considers the output from Step 1365 or Step 1355 and selects an approved appointment. In 1375, the Central Controller 300 checks the Service Database 375 for the requested service to determine whether or not the Service Provider 350 requires an Appointment Description from the End User (e.g., I need transmission work). It should be noted that Step 1375 can be modified to prompt the End User for any other information required by a given Service Provider 350.

If the Service Provider 350 requires an Appointment Description, then in Step 1377, the Central Controller 300 presents the End User with a form to enter the Appointment Description. If not, processing continues to Step 1385. In Step 1380, enters their Appointment Description and process continues to Step 1385. In Step 1385, the Central Controller 300 checks the Service Database for the requested service to determine whether or not the Service Provider 350 requires a Credit Card Hold from the End User. It should be noted that Steps 1385-1400 can be removed on the request by the Service Provider 350. These steps are described to illustrate how the application can restrict users from abusing the system 10.

If the Service Provider 350 requires a Credit Card Hold, then in Step 1390, the Central Controller 300 presents the End User with a form to enter their Credit Card information. If not, processing continues to Step 1394.

In Step 1391, the User enters his credit card information and processing continues to Step 1392. In Step 1392, the Central Controller 300 submits the End User's credit card information along with the Service Hold Price 718 to an online credit card processing service such as Cybercash™. In Step 1393, if the End User's credit card information is verified, then processing continues to Step 1395. If the End User's credit card information is rejected, then the End User is returned to Step 1390 to re-enter his information.

In Step 1395, the Central Controller 300 retrieves the Cache Update Timestamp 908 for each of the Resources and compares the Cache Update Timestamps 908 with those stored in Step 1340. If the timestamps are the same, then the appointment is still available and processing continues to Step 1396. If the timestamps are different, this means that one or more of the Resource Cache strings has been modified by another End User's actions since Step 1340. The Central Controller 300 then re-applies the operations in Step 1340 to determine whether the requested Service, date, and time are still available. This step is required in a multi-user environment to ensure that timeslots are not “double booked” between more than one End User.

In Step 1396, if the requested Service, Date, and Time are still available then processing continues to Step 1397. If not then, in Step 1398, the End User is notified of the appointment rejection and is returned to Step 1325. In Step 1397, the Central Controller 300 creates a row in the Appointment Database 380 and stores all relevant information gathered in the above steps. Central Controller 300 creates rows in the Appointment/Resource Mapping Database 390 for each resource required to execute the reserved service. Central Controller 300 updates resource caches in the Resource Cache Database 385 for the reserved resources.

III. Illustrative Example

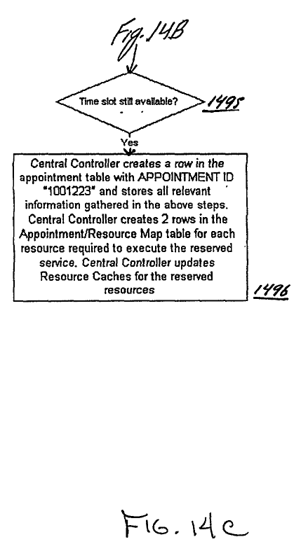

Referring now to FIG. 14, processing starts at Step 1400, and proceeds to Step 1405 where End User “Joe Manatu” accesses the Central Controller 300 via the Internet via User Interface 310. At Step 1410, it is necessary for “Joe Manatu” to have registered with the Central Controller 300 before scheduling an appointment; therefore, “Joe Manatu” is presented a form to login to the Central Controller 300. At Step 1415, “Joe Manatu” enters “joe@earthlink.net” as his unique email and “SKDIKJE39” as his unique password. At Step 1417, Central Controller 300 locates a row with unique identifier “544323” in the End User Database 360 that corresponds to “joe@earthlink.com” and “SKDIKJE39”, so “Joe Manatu” proceeds to Step 1417.

In Step 1420, “Joe Manatu” locates the registered Service Provider “A & A Autobody” on system by entering A & A into the keyword search engine. In Step 1425, the Central Controller 300 retrieves “A & A Autobody's” information and services by joining Service Provider Id 502 in the Service Provider Database 365 and Service Provider Id 704 in the Service Database 375. In Step 1425, the Central Controller 300 presents the list of services for “A & A Autobody” including the Services titled “Automatic Transmission Service/Repair” and “Batteries—Sell and install” to “Joe Manatu” along with a form allowing “Joe Manatu” to enter a desired date and time. In Step 1430, “Joe Manatu” selects the “Batteries—Sell and install” Service, and enters Jul. 21, 2000 as a preferred starting date and 8:45 am as a preferred start time. In Step 1435, the Central Controller 300 accesses the Appointment Database 800 and determines whether “Joe Manatu” already has an appointment for the requested service and start time, i.e., “Batteries—Sell and Install” on Jul. 21, 2000. The verification is performed by using the end user ID “544323” for “joe manatu” as an index into Database 380 to determine whether there is a record in the Appointment Database 380 that matches the supplied End User Id 804 of “544323”, the Service ID “5668”, and the start timestamp of Jul. 21, 2000.

If it is determined that there is no previous appointment at step 1435, in step 1440, the Central Controller 300, proceeds to retrieve the fields associated with the service “Batteries—Sell and Install” from the following databases: Service Database 375, Resource Database 370, and Resource Cache Database 385 by joining Service Id 702 from the Service Database 375 corresponding to “Batteries—Sell and install”, Service Id 1002 from the Service/Resource Mapping Database 395, Resource Id 1004 from the Service/Resource Mapping Database 395, Resource Id 602, from the Resource Database 370, and Resource Id 904 from the Resource Cache Database 385 corresponding to Jul. 21, 2000. The records retrieved from the respective databases are as follows: records 614, 616 are returned from the Resource Table 600; record 726 is returned from the Service Table 700; record 914 is returned from the Resource Cache Table 900; and records 1006, 1008 are returned from the Service/Resource Mapping Table 1000.

In step 1445, the Central Controller 300 checks the Resource Cache strings to verify that the requested time is available. From row 726, the Central Controller 300 knows that the “Batteries—Sell and install” has a Service Time Interval 708 of 30. This means that the Service takes an average of 30 minutes to complete. From Step 1430 the Central Controller 300 knows that “Joe Manatu” has requested 8:45 as a start time. The Central Controller 300 calculates that “Joe Manatu” is requesting Resource Cache positions 525-555 on Resource Cache rows 912 and 914. Therefore, for this Appointment to be available, then there must be 30 consecutive “0's” from Resource Cache positions 525 to 555. In Step 1450, the Central Controller 300 scans the Cache String 910 field from returned rows 912 and 914 and discovers that the resources are available during the requested time. Therefore, the Service Provider 350 is able to provide the requested service on the requested date.

In Step 1465, the Central Controller 300 presents a form allowing “Joe Manatu” to select “Jul. 21, 2000 8:45 am”. In Step 1470, “Joe Manatu” selects “Jul. 21, 2000 8:45 am”. In Step 1475, from the Service Table row 726, the Central Controller 300 knows that the “A & A Autobody” has an Appointment Description Prompt 720.

In Step 1477, Central Controller 300 Prompts “Joe Manatu” to “Please enter the desired Battery manufacturer.” In Step 1480, “Joe Manatu” enters a service description request, “Please install a System V Optima battery”. In Step 1485, from the Service Table row 726, the Central Controller 300 determines that the “A & A Autobody” requires a Credit Card Hold for this service. In Step 1490, the Central Controller 300 presents a form for “Joe Manatu” to enter a credit card type, number, and expiration date. In Step 1491, “Joe Manatu” enters “VISA” as the credit card type, “4776873303780065” as the credit card Number, and “09/02” as the expiration date. In Step 1492, Central Controller 300 submits credit card information and service hold price to an online verification service, such as Cybercash™, for verification. In Step 1493, the online verification service returns a positive verification code.

In Step 1494, the Central Controller 300 retrieves rows 912 and 914 from the Resource Cache Table 900. Then the Central Controller 300 compares the Cache Update Timestamp 908 from both rows with the timestamps stored in Step 1440. In Step 1495, the Central Controller 300 discovers that the timestamps have not changed.

In Step 1496, Central Controller 300 creates a row in the appointment table with APPOINTMENT ID “1001223” and stores all relevant information gathered in the above steps. Central Controller 300 creates two rows in the Appointment/Resource Map Table 1100 for each resource required to execute the reserved service. Central Controller 300 updates resource caches for the reserved resources.

What has been described herein is merely illustrative of the application of the principles of the present invention. For example, the functions described above and implemented as the best mode for operating the present invention are for illustration purposes only. As a particular example, for instance, other design configurations may be used for the system which provide similar operation as the system described above. Other arrangements and methods may be implemented by those skilled in the art without departing from the scope and spirit of this invention.

What is claimed is:

1. An interactive scheduling system for performing a scheduling process, the system comprising:
at least one end user computer operable by one of a plurality of end users for transmitting scheduling requests via a network;
at least one service provider computer operable by one of a plurality of service providers for transmitting service schedules via the network; and
a central controller for receiving said scheduling requests and said service schedules and performing said scheduling process, where said scheduling process includes providing said service schedules to said plurality of end users via the network to enable said plurality of end users to transmit said scheduling requests for services provided by said plurality of service providers and to determine if at least one available date and time of said service schedules matches said transmitted scheduling requests.
